(19) United States
(12) Patent Application Publication
(10) Pub. No.: US 2020/0333494 A1
(43) Pub. Date: Oct. 22, 2020

(54) SYSTEMS AND METHODS FOR DETECTION OF WELL PROPERTIES

(71) Applicant: Indiana University Research and Technology Corporation, Indianapolis, IN (US)

(72) Inventor: Peter J. Schubert, Indianapolis, IN (US)

(73) Assignee: Indiana University Research and Technology Corporation, Indianapolis, IN (US)

(21) Appl. No.: 16/850,484

(22) Filed: Apr. 16, 2020

Related U.S. Application Data
(63) Continuation of application No. 15/337,812, filed on Oct. 28, 2016, now abandoned.
(60) Provisional application No. 62/248,596, filed on Oct. 30, 2015.

(51) Int. Cl. G01V 1/50

(52) U.S. Cl. CPC G01V 1/50; G01V 2210/1299; G01V 2210/1214; G01V 2210/622; G01V 2210/612; G01V 2210/1429

(57) ABSTRACT

Methods comprising electronically receiving information of a reflection of a known first sound pulse, electronically receiving information of a reflection of a known second sound pulse, determining, by a processor, a change in a first property between a known first sound pulse and a reflection of the known first sound pulse, determining, by the processor, a change in a second property between a known second sound pulse and a reflection of the known second sound pulse, comparing, by the processor, the change in the first property of the first known sound pulse with the change in the second property of the second known sound pulse, and determining, by the processor, a condition of a well in response to the comparison of the change of the first property with the change of the second property are disclosed. Systems for determining a condition of a well are also disclosed.

### CROSS-REFERENCE TO RELATED APPLICATIONS

This application is a continuation of U.S. application Ser. No. 15/337,812, filed Oct. 28, 2016, which in turn claims priority to U.S. Provisional Application Ser. No. 62/248,596, entitled SYSTEMS AND METHODS FOR DETECTION OF WELL PROPERTIES filed on Oct. 30, 2015, the entire disclosure of which are hereby expressly incorporated by reference.

### FIELD OF THE DISCLOSURE

This disclosure relates to methods and systems for determining various properties of wells. More specifically, this disclosure relates to contactless methods for determining both static and dynamic changes in various properties of wells.

### BACKGROUND

Wells may be cylindrical holes dug substantially vertically into the earth for the purposes of extracting underground resources such as water, petroleum, or natural gas. For wells that do not supply their own pressure (e.g., Artesian wells), it may be important to measure various static and dynamic parameters. As a non-limiting example, many U.S. states require that on-property pumped water wells be tested for recovery rates. Well recovery determination may include the methods of approximating the simultaneous activation of all sources of draw on the well water, which draws down the level, and observing the recovery of the water level (e.g., as the well is filled back in from the surrounding water table). Pumped oil wells may desire this capability also to provide data for the forecast of well productivity. A too-slow recovery however, could leave property occupants without water and could also increase the risk of water contamination.

For example, the recent surge in horizontal drilling and hydraulic fracturing can increase the risk of trapped subterranean gases such as methane and radon entering existing water wells. Also, organizations devoted to the supply and monitoring of groundwater such as water utility providers may wish to continually monitor various properties of the well, such as monitoring the water table for unexpected changes, without wasting or contaminating well resources.

Currently, manual methods of well testing are used and may include lowering a weighted bobber on a tape measure. More sophisticated versions employ an automated winding system that may employ a water sensor on the bobber to continually adjust the tape measure length to the dynamic depth of the liquid in the well. However, contact with the well water may increase the possibility of well contamination, and in most jurisdictions regulations call for the in-well portion of the system to be sterilized or disinfected between subsequent well tests (e.g., by a professional well tester). In practice, the regulations may not always be followed, policing may be very difficult, and compliance may be costly.

Non-contact methods of well characterization may use sound waves and time-of-flight measurements to capture the echo from underground liquid surfaces. For example, some existing technologies use a solenoid-driven loudspeaker as both transmitting source and as a microphone for detection of the received signal. As a non-limiting example, a brief duration audio pulse of 300 Hz frequency, having a wavelength slightly more than 1 meter, may be issued from a speaker at the wellhead (top of the well bore). A counter may be started, typically associated with an electronic or crystal oscillator of known frequency, and a detection circuit, either analog or digital, may be used to indicate return of the echo signal. In at least one case, the speaker may be approximately the same diameter as the well bore, and rests on the casing. In at least one other case, the speaker's audio signal may be directed through a vent hole (typically ⅝ inch diameter) in the wellhead cover. In either case, there may be challenges to robust detection of the desired echo.

One such challenge may be the possible presence of a misalignment between the well casing sunk through soil to the well bore through subsurface rock strata. In some wells, semicircular ledges may be formed unless the alignment of the well casing alignment is perfect. Misalignment of the well casing can often present a surface capable of reflecting sound waves, even though the level is above the level of the water in the well.

Another challenge involves piping sound through tubes into a vent hole, which may be typically offset from the center of the cover. The offset of the vent hole can create a non-symmetric wave guide for the sound energy, which can frustrate non-contact methods.

Also, in some instances, debris may be floating on the surface of the water or oil, which may scatter the sound waves in ways that may be nearly impossible to predict or correct for.

Multi-path interference may also confuse detection circuitry as various components of the reflecting waves may be rendered incoherent from irregularities or defects such as a leak spewing water into the well through the casing itself. Reflections at the well cover may echo multiple times and provide confusing readings to the detection circuitry. Because of these—and other—irregularities, current well detection devices may give false or inconsistent readings.

Also, existing technology for well characterization generally does not include the capability to detect the cover gases existing in the well. In some instances, the presence of various gases (e.g., methane, radon, etc.) can affect sound waves when contactless methods are used.

Accordingly, development of advanced non-contact methods and systems for determining the condition of a well may help to advance current well maintenance, auditing, and planning. Also, development of systems and methods for determining the gas composition may help to advance well maintenance, auditing, and safety.

### SUMMARY

Methods comprising electronically receiving information of a reflection of a known first sound pulse, electronically receiving information of a reflection of a known second sound pulse, determining, by a processor, a change in a first property between the known first sound pulse and the reflection of the known first sound pulse, determining, by the processor, a change in a second property between the known second sound pulse and the reflection of the known second sound pulse, comparing, by the processor, the change in the first property of the first known sound pulse with the change in the second property of the second known sound pulse; and determining, by the processor, a condition of a well in response to the comparison of the change of the first property with the change of the second property are disclosed.

Also disclosed are systems including a receiver, a processor in electrical communication with the receiver, wherein the processor electronically receives information of a reflection of a known first sound pulse, electronically receives information of a reflection of a known second sound pulse, determines a change in a first property between the known first sound pulse and the reflection of the known first sound pulse, determines a change in a second property between the known second sound pulse and the reflection of the known second sound pulse, compares the change in the first property of the first known sound pulse with the change in the second property of the second known sound pulse, and determines a condition of a well in response to the comparison of the change of the first property with the change of the second property.

The methods and systems disclosed herein include various methods and system that have resulted in a novel approach to the detection of gaseous contaminants inside water wells, in addition to measuring water depth and recovery rate after draw-down. Advance acoustic well sounders disclosed herein may use digital signal processing and a unique profile of sound energy to provide detailed information about well condition in a low-cost design.

Many states and some mortgage companies require measurement of well specific capacity when a property is sold, which is a significant market for well sounding, but other markets and/or applications are within this disclosure. For example, ingress of sub-surface gases, e.g. radon or natural gas, modify the speed of sound inside the well, and may be detected with various systems and methods disclosed herein.

As an example application, a water well on a property nearby to a site conducting lateral drilling and hydraulic fracturing could be continuously monitored for changes in the cover gas above the water level. For instance, should methane (and other volatile hydrocarbons) be released into the well, the change in speed of sound can be detected, flagging the well for closer scrutiny. This can provide an early indication of a well being compromised in a cost-effective manner.

The methods and systems disclosed herein may also permit the monitoring of fracking operations, especially when local citizens are concerned about drinking water contamination. The extraction developer could engage an insurance provider to establish a premium which insures the citizens against well contamination. If no contamination occurs, then the developer has only paid the premium. However, should contamination occur (via cracked casing, incomplete sealing, or geological weaknesses) the insurer would make the property owner whole in regards to their access to clean water. In this way, community or individual concerns can be ameliorated in a fair and transparent manner.

### BRIEF DESCRIPTION OF THE DRAWINGS

The above-mentioned and other features and objects of this disclosure, and the manner of attaining them, will become more apparent and the disclosure itself will be better understood by reference to the following description of embodiments of the disclosure taken in conjunction with the accompanying drawings, wherein:

FIG. 1 illustrates a method for determining a condition of a well according to various embodiments;

FIG. 2 illustrates a method comprising determining a confidence measure of the first sound pulse according to various embodiments;

FIG. 3 illustrates a method comprising determining a confidence measure of the second sound pulse according to various embodiments;

FIGS. 4A and 4B illustrate various systems for determining well properties according to various embodiments;

FIG. 5 illustrates an exemplary shape of a pulse in time space according to various embodiments;

FIG. 6 illustrates an attenuation schedule versus time-of-flight for a response in accordance with various embodiments;

FIG. 7 illustrates overlaid responses according to various embodiments;

FIGS. 8 and 9 illustrate various logic sequences according to various embodiments;

FIG. 10 illustrates a scan of frequencies according to various embodiments;

FIG. 11 illustrates an inter-cluster ordering of frequencies according to various embodiments; and

FIG. 12 illustrates the effect of humidity on the speed of sound.

Corresponding reference characters indicate corresponding parts throughout the several views. Although the drawings represent embodiments of the present disclosure, the drawings may be not necessarily to scale and certain features may be exaggerated in order to better illustrate and explain the present disclosure. The exemplification set out herein illustrates an embodiment of the disclosure, in one form, and such exemplifications may be not to be construed as limiting the scope of the disclosure in any manner.

### DETAILED DESCRIPTION

The embodiments disclosed below may not be exhaustive or limit the disclosure to the precise form disclosed in the following detailed description. Rather, the embodiments may be chosen and described so that others skilled in the art may utilize its teachings.

As used herein, the modifier “about” used in connection with a quantity may be inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

The scope of this disclosure includes non-contact methods and systems for detecting the static and dynamic depth of liquid within a well. In some embodiments, a first series of short-duration sound pulses (chirps) of specific pre-selected frequencies may be used to provide multiple determinations of time-of-flight estimates for the various axially-oriented reflecting surfaces within a well, including the liquid depth. A first confidence measure may be determined, which may—in some embodiments—quantify the proximity of multiple readings to a centroid of a cluster of time-of-flight readings. A second confidence measure may quantify the proximity of a given cluster to a schedule of attenuation expected over distance or depth, according to various embodiments disclosed herein. Some embodiments may also include a third confidence measure that may indicate the potential presence of a multiple echo between pairs of cluster centroids.

Thus, in various embodiments, the confidence measure of the first sound pulse may comprise at least one of (i) quantifying a proximity of multiple readings to a centroid of a cluster of time-of-flight readings, (ii) determining a proximity of a given cluster to an attenuation schedule, or (iii) determining a presence of an echo between centroids of a cluster.

In some embodiments, a second known sound pulse may be a continuous wave signal, such as a slowly-varying continuous wave signal scanned in frequency. As used herein, the continuous sound signal may be an analog or digitally-swept wave signal. In various embodiments, the response signal of the continuous wave signal may be measured and the standing wave amplitude at the well head may indicate the presence of constructive and destructive interference of sound waves within the well. From a predicted profile of peaks and nulls in a graph of amplitude versus continuous wave frequency, a fourth confidence measure assesses the presence and strength of quarter wavelength resonances and how well they correlate with an estimate of well depth derived from the first three confidence measures. Thus, in various embodiments, a determination of the confidence measure of the second sound pulse may include determining a resonance value. The fourth measure may be used to further increase the confidence of the final reading for well depth and, thus, may provide increased confidence (robustness) in the decision (estimation of a well property).

With reference to the cluster of time-of-flight readings of the present disclosure, in various embodiments, the cluster of time-of-flight readings may be associated with the final well depth reading. Also, in some embodiments, the inter-cluster sequence and spread of the first series of various frequency chirps may be used to estimate the mixture of in-well gases based on the difference in sound velocity with frequency—which may be different for different gases. In various embodiments, aforementioned steps may be repeated over time to provide a dynamic response of the well depth and gas composition, such as recovery after a draw-down of the liquid therein, and a method of detecting changes over time in the possible intrusion of various gases into a well.

Sound waves may be characterized by amplitude, or power, frequency and wavelength. The frequency (v) and wavelength (l) may be related through the frequency-dependent velocity of sound (c), as described in Equation (1):

$$v = \frac{c}{l} \qquad Eq . 1$$

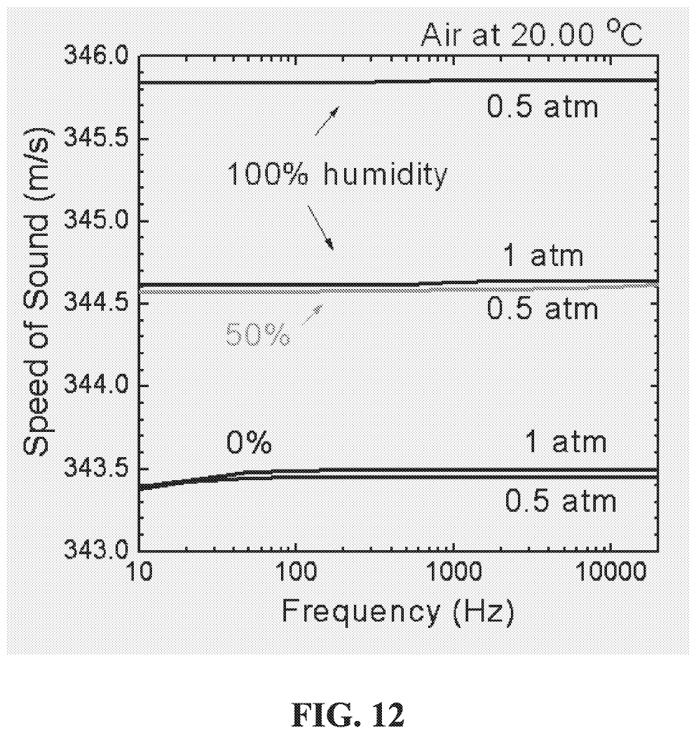

The speed of sound under ideal assumptions may be calculated from the Newton-Laplace equation, shown below as Equation (2), where γ is the adiabatic expansion factor, k is Boltzmann's constant, T is the absolute temperature, and m is the mass of the gas molecule. For an ideal gas velocity may be constant throughout most of the frequency ranges of interest, although with some non-ideal gases, sound velocity may change significantly in the ultrasonic range. The average speed of sound waves in air is typically about 340 m/s. In some instances, humidity may affect the speed of sound (e.g., due to mixing of the lighter water vapor molecules along with the predominantly nitrogen and oxygen molecules present in air). For example, with temporary reference to FIG. 12, FIG. 12 illustrates the speed of various sound waves based on the humidity in the air.

The presence of other gases, such as methane, can also affect the speed of sound waves. Methane (CH₄) has a lower molecular weight (16.04 AMU) than air gases (28.02 for N₂ and 32 for O₂), and will cause an increase in the speed of sound, according to Eq. 2:

$$c = \sqrt{\frac{γ k T}{m}} \qquad Eq . 2$$

Sound speed may also vary with temperature. In general, the temperature within a well may be relatively constant and lies between about 50° F. and about 58° F. Some embodiments may include a measurement of temperature within the well, and use this to compensate for the time-of-flight and standing wave detection as described herein. This compensation may be relatively simple, and may be well understood by those skilled in the art with the benefit of this disclosure.

Processing of waveforms may be aided through the methods known as Fourier analysis, using Fourier transform techniques to convert a given signal between temporal or time-based “space” and frequency “space”. In both spaces, the amplitude or power of the audio signal may be relevant, but in the former it may be distributed in time and in the latter the power may be distributed in frequency. The descriptions below apply to both time space and frequency space as will be indicated.

As used herein, “attenuation” may be used to describe a reduction in the power of an audio signal, and may be measured in decibels (dB). The defining equation for a decibel of power attenuation relates the detected signal (P_{D}) to the original source signal (P_{S}) may be given by Equation (3), and may be a negative number for attenuation:

$$dB = 20 log \frac{{P}_{D}}{{P}_{S}} \qquad Eq . 3$$

Attenuation of an acoustic signal may be caused by many factors, the most important of which may, in some instances, be dispersion. A point source of sound in an open space may be reduced in power as the sound wave travels away from the source. This attenuation follows an inverse square law (e.g., a doubling of distance results in a four-fold reduction in signal power). Within a waveguide the attenuation may follow a simple inverse law, or other non-integer inverse power law, for example, due to the constraint in dimensionality.

Another source of signal attenuation, which may also be accounted for according to the various embodiments disclosed herein, may be absorption (e.g., where signal power is lost through contact with elastic media or heating of the fluid medium through which the waves propagate, such as air or other gases). Sound waves may also be scattered, such as by intervening surfaces or dust particles suspended in the fluid medium, which may also be accounted for in accordance with the embodiments disclosed herein.

As used herein, the term “interference” may be understood to include a property whereby sound waves may add together or nullify each other, being referred to, respectively, as constructive or destructive interference. Common phenomenon in waveguides that may be accounted for in the various embodiments disclosed herein include accounting for a reflected wave that overlaps with the source wave, which may form regions where the amplitude may be greater than, or less than, the original source wave. In a steady state situation with continuous delivery of acoustic power from the source, these patterns of interference may be called “standing waves.”

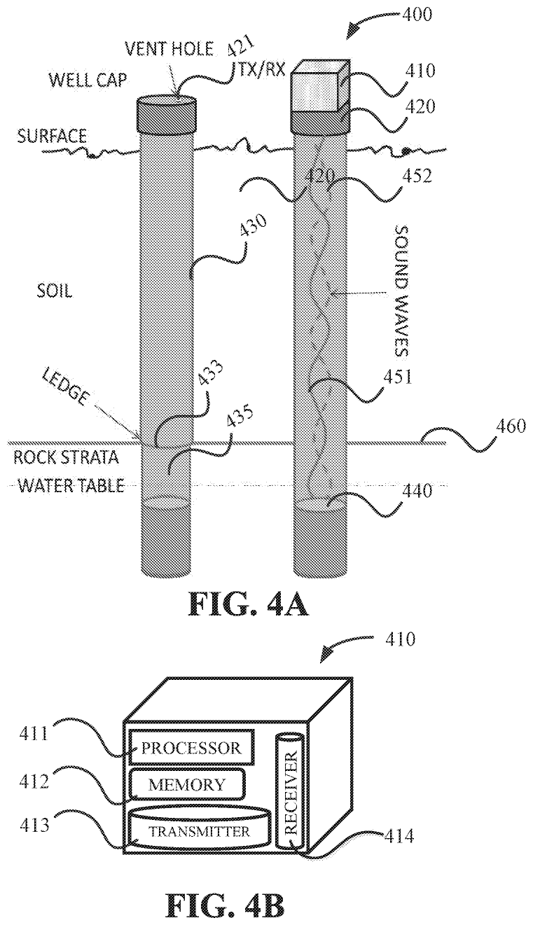

According to various embodiments, it may be also possible to direct the sound through the vent hole 421 indicated in FIG. 4A. Although complications may arise due to the more complicated and less symmetric geometry of the waveguide coupling of off-center vent hole 421 in well cap 420, the various embodiments disclosed herein may account for the more complicated and less symmetric geometry and may be modified by those skilled in the art with the benefits provided by the instant disclosure.

FIGS. 4A and 4B illustrate systems according to various embodiments. Well detection system 410 may comprise a receiver 414 and a processor 411 in electrical communication with the receiver 414. In various embodiments, processor 411 may be configured to electronically receive information of a reflection of a known first sound pulse 451. Processor 411 may also electronically receive information of a reflection of a known second sound pulse 452. In various embodiments, at least one of the electronically receiving information of a reflection of the known first sound pulse or the electronically receiving information of a reflection of the known second sound pulse may be received from a receiver in electrical communication with the processor.

In various embodiments, processor 411 may determine a change in a first property between the known first sound pulse and the reflection of the known first sound pulse 451. Processor 411 may also determine a change in a second property between the known second sound pulse and the reflection of the known second sound pulse 452.

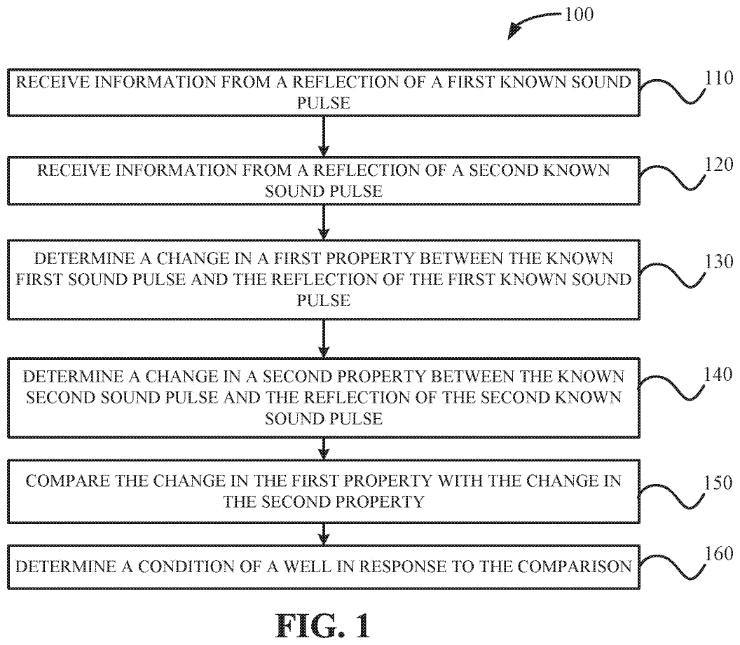

In various embodiments, processor 411 may compare the change in the first property of the first known sound pulse with the change in the second property of the second known sound pulse and may determine a condition of a well based on the comparison of the change of the first property with the change of the second property. The condition is not particularly limited and may comprise at least one of a depth of the well, an identity of a gas in the well, a concentration of a gas in the well, a presence of ledges within the well, a recovery rate of the well, a presence of debris in the well, or a presence of a leak in a casing of the well. Though examples of specific well conditions are used throughout this disclosure, the exemplary use of one condition of a well is not meant to exclude or limit this disclosure to only that particular well condition. Thus, it is expected that—with the benefit of this disclosure—those skilled in the art may be able to adapt one exemplary method for determining a specific condition of a well to determine another non-exemplified condition of a well. Furthermore, with the benefit of this disclosure it is expected that both static and dynamic conditions of the well may be determined with the systems and methods disclosed herein. Thus, in various embodiments, methods (such as method 100 in FIG. 1) may be repeated at least once to determine a dynamic response of the well based on the determination of a change of the condition of the well.

In some embodiments, system 410 may also comprise a transmitter 413 capable of transmitting at least one of the first known sound pulse or the second known sound pulse. Transmitter 413 is not particularly limited and may comprise at least one of a solenoid current-driven membrane speaker, a voltage-driven piezoelectric speaker, or a capacitive plate speaker. In some embodiments, the transmitter 413 and receiver 414 may be combined as the transceiver. In other embodiments, transmitter 413 and receiver 414 may be separate (e.g., as illustrated in FIG. 4B).

Processor 411 may also be in electrical communication with non-transitory memory 412. Memory 412 may be a computer readable storage medium including instructions for determining a property of a well. In various embodiments, the instructions, when executed by a processor 411 in electrical communication with receiver 414, cause the processor 411 to perform operations comprising determining, from electronically received information, a change in a first property between a known first sound pulse and a reflection of the known first sound pulse, determining, from electronically received information, a change in a second property between a known second sound pulse and a reflection of the known second sound pulse, comparing the change in the first property of the first known sound pulse with the change in the second property of the second known sound pulse, and determining a condition of a well in response to the comparison of the change of the first property with the change of the second property.

FIG. 4A illustrates well system 400 in accordance with various embodiments. In well system 400, the well system may comprise a well cap 420 with a vent hole 421. Well cap 420 may cap a well which may comprise a first casing 430 and a second casing 435. As illustrated in FIG. 4A, first casing 430 and second casing 435 may connect near or at the rock strata 460 and may form a ledge. System 410 may be configured to rest atop well cap 420 may be configured to receive information of a reflection of a known first sound pulse 451 and a second sound pulse 452. As illustrated in FIG. 4A, a first known and a second known sound pulse may be sent and may reflect off the water surface 440. The resulting reflection of a known first sound pulse 451 and a second sound pulse 452 may be received and analyzed to determine a characteristic, such as the true depth of the well in accordance with various embodiments.

FIG. 1 illustrates a method 100 for determining a characteristic of a well. First, information may be electronically received from a reflection of a known first sound pulse (step 110), for example, with system 410. Information of a reflection of a known second sound pulse may then be electronically received (step 120). Then a processor (e.g., processor 411), may determine a change in a first property between the known first sound pulse and the reflection of the known first sound pulse (step 130) and, in various embodiments, the processor may also determine a change in a second property between the known second sound pulse and the reflection of the known second sound pulse (step 140). Then, the processor may compare the change in the first property of the first known sound pulse with the change in the second property of the second known sound pulse (step 150) and, thus, may also determine a condition of a well in response to the comparison of the change of the first property with the change of the second property (step 160).

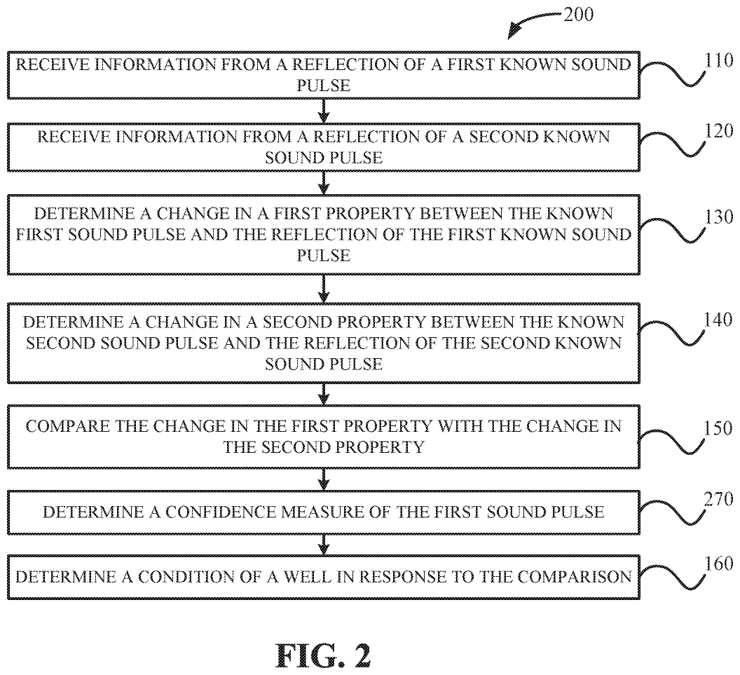

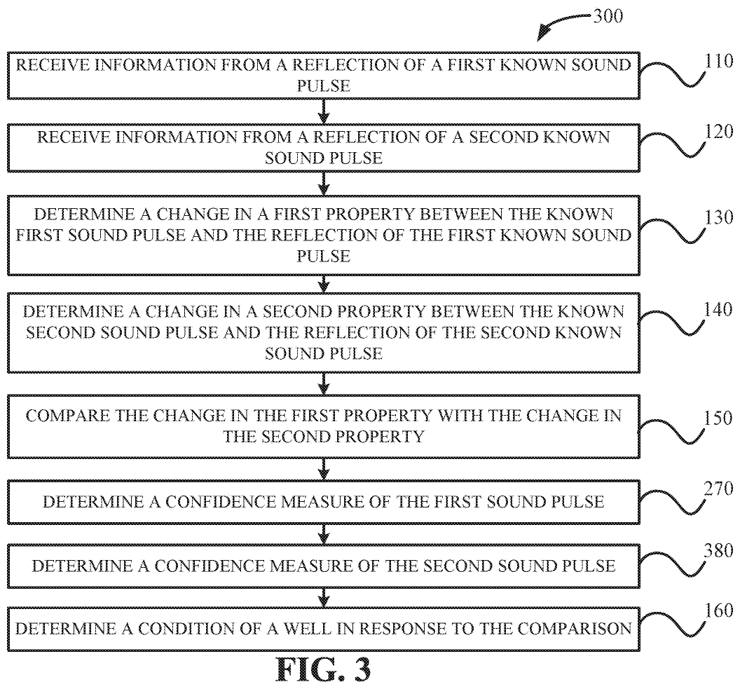

In various embodiments, a confidence measure may be determined. For example, with reference to FIG. 2, method 200 may comprise determining a confidence measure of the first sound pulse (step 270). Likewise, in various embodiments, a confidence measure of the second sound pulse may also be determined, as shown in FIG. 3 as step 380. Also, in various embodiments, such as that illustrated in method 300 of FIG. 3, a confidence measure of both the first sound pulse and the second sound pulse may be determined (steps 270 and 380 respectively).

In various embodiments, with a well depth and gas composition measuring system the processor may run algorithms as described below, and may further include electronic circuitry for the generation, amplification, and detection of acoustic signals over a variety of frequencies ranging from subsonic (about down to 20 Hz) to ultrasonic (up to about 900 kHz). The algorithms described herein may be incorporated into many embodiments described. In various embodiments, at least one of the first known sound pulse or the second known sound pulse may be within a frequency range of about 20 Hz to about 300 Hz or about 300 Hz to about 20,000 Hz. Also in various embodiments, at least one of the first known sound pulse or the second known sound pulse may be within a frequency range of about 20,000 Hz to about 200,000 Hz or about 30,000 Hz to about 950,000 Hz. Thus, at least one of the first known sound pulse or the second known sound pulse may be within a frequency range of about 20 Hz to about to about 950,000 Hz.

The circuitry may be accomplished by one or more methods known to those skilled in the art, and may be purely digital, or may also contain analog circuitry. In various embodiments, the circuitry may be included in the transmitting portion (TX) and the receiving portion (RX) enclosure (“TX/RX enclosure”), and powered either by battery, generator, solar panel, or by grid-tie. The signal processing functions and algorithms may be included in the TX/RX enclosure, or they may be performed off-line using a computer, tablet, smart phone, or other electronic computational device which includes a display, printout, or data storage of the results for immediate or later review.

Communications between TX/RX circuitry and a possible off-line computational device may be wired or wireless using such methods known to those skilled in the art. Changes in the well depth or gas composition may then be determined by plotting the results of multiple measurements against time. From such a graph additional valuable information may be obtained, such as the recovery profile of a water well after a significant draw of water for purposes of assuring the flow rate of a well, or for determining the intrusion over time of natural gas into a well.

Various methods disclosed herein may begin with a first series of short-duration pulses, or chirps, for example, using at least two (2) different frequencies. In some embodiments, at least four (4) frequencies within the following ranges may be used:
1. Sonic range of 20-300 Hz
2. Sonic range of 300-20,000 Hz
3. Ultrasonic range of 20,000-200,000 Hz
4. Ultrasonic range of 30,000-950,000 Hz

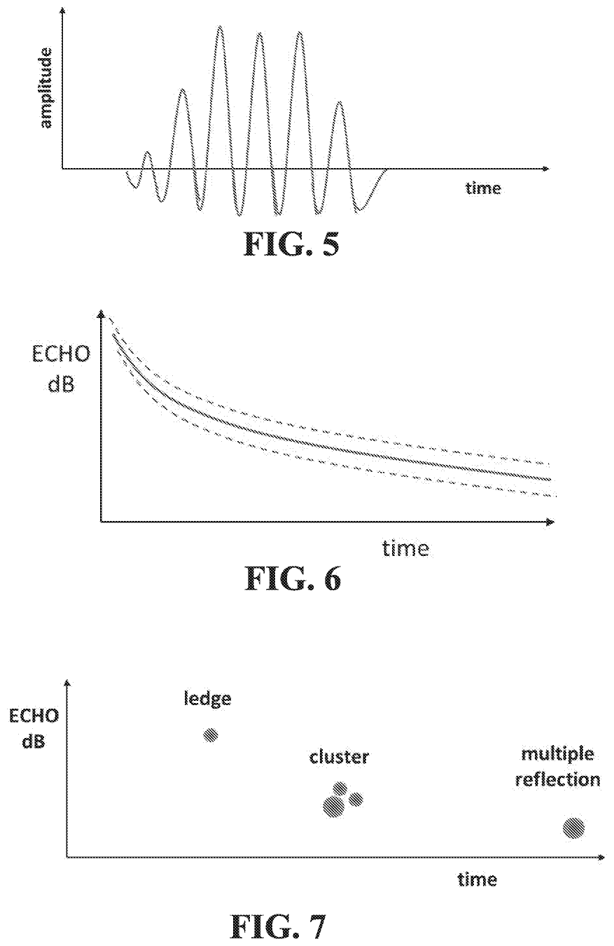

The chirp or signal may be generated by a function generator and comprise a sinusoidal or triangular waveform selected from the frequency ranges above yet contained within an envelope of short duration, said duration being longer than the period (inverse of frequency) of the waveform but shorter than the time-of-flight expected from the shallowest well depth to be measured. The shallowest well depth may be determined by a pre-set parameter from the factory, or modified by data entry from the user in the field. The general shape of the chirp pulse in time space may be illustrated schematically in FIG. 5.

Each of the first series of chirps may be emitted with sufficient time between to allow time-of-flight return signals from the deepest well depth to be measured. This maximum well depth may be pre-set or user-adjusted (e.g., within the range of 1500-3500 ft.).

Upon the emittance of each chirp, a timer having sufficient resolution (e.g., about or at least ten times shorter in duration than the time-of-flight expected from the shallowest well depth), may be used to indicate the duration between emission and reception of the various echoes. The echoes may be measured by the RX device in units of dB. Attenuation of the signal with depth may depend on many factors (e.g., the casing material, well bore (diameter), rock type, intervening dust or liquid, or imperfections, etc.). In some embodiments, it may be possible to define an expected level of attenuation with depth.

For example, FIG. 6 depicts an exemplary attenuation schedule, showing a mean attenuation versus time, and hence depth (solid line), of a well-reflected signal, such as would be expected upon reflection from a specular surface of liquid at the bottom of a well. Also, as shown in FIG. 6, error bars above and below (dashed lines) may be used and may indicate a lowering of confidence of a true well depth signal with greater deviation from the mean schedule. For example, the presence of a ledge (as illustrated in FIG. 4A) may introduce a signal which may be sooner in time than the desired well depth measurement, but will generally be lower in dB than the schedule owing to the smaller cross section available for reflection. There may also be multiple reflections between the true well depth and the well cap, if present.

These scenarios are exemplified schematically in FIG. 7, where multiple time-of-flight returns from the first series of chirp frequencies may be overlaid. There will generally be clusters of readings as indicated.

Below are various methods for measuring various confidence measures according to some embodiments. In various embodiments, the confidence measure may be derived from the overlay of chirp series time-of-flight (TOF) responses illustrated in Eq. 4, where x is an elapsed time, and y is a response to a sound pulse.

$$\begin{matrix}Confidence\_ 1 ( i ) = C 1 A \times N \times {( \sqrt{{\sum }_{j} ( {( {x}_{j} - {\overline{x}}_{i} )}^{2} + {( {y}_{j} - {\overline{y}}_{i} )}^{2} )} )}^{- 1} & Eq . 4 \\ Confidence\_ 2 ( i ) = max ( \frac{\vert a {x}_{i} + b {y}_{i} + c \vert}{\sqrt{{a}^{2}} + {b}^{2}} , 1.0 ) & Eq . 5 \\ Confidence\_ 3 ( i , j ) = Confidence\_ 1 ( i ) \times Confidence\_ 2 ( i ) \times Confidence\_ 1 ( j ) \times Confidence\_ 2 ( j ) & Eq . 6\end{matrix}$$

In various embodiments, Confidence_1, Confidence_2 and Confidence_3 (i.e., Eq. 4, Eq. 5, and Eq. 6 respectively) may be derived from TOF overlays.

The first confidence measure Confidence_1 indicates the tightness or proximity of each potential cluster. Clusters may be identified using methods such as k-means, k nearest-neighbor, or other methods known to those skilled in the art with the benefit of this disclosure. Within each cluster Confidence_1 may be based on the root mean square distance to the centroid of the cluster. The inverse of this measure may be summed over the number of chirp frequencies, normalized to the number N of such frequencies, and multiplied by a parametric constant CIA determined by at least one of the three methods indicated below:
a. by a C1B percent of a root mean square distance to cluster i centroid, where C1B is an experimentally determined parameter which is positive and finite, and is constant regardless of the absolute magnitude of the signal power;
b. by a parametric threshold (e.g., as a function of distance), which may be a polynomial or piece-wise linear function; or
c. by a smallest root mean square distance of i clusters, either captured in real-time during the determination of well parameters and compared on that basis, or may be pre-determined and factory-programmed, or may be user-changeable through an appropriate programming interface.

The second confidence measure Confidence_2 indicates how closely the cluster centroid lies to the attenuation schedule of FIG. 6. The absolute distance may be bounded to be greater than 1 dB to avoid dividing by zero in the algorithm.

The third confidence measure Confidence_3 may be a composite of Confidence_1 and Confidence_2 applied where there may be a cluster j identified for which TOF(j) may be an integral multiple of the TOF(i) for another cluster. This composite confidence measure may be used to detect multiple strong reflections which may be expected to be significant only for specular reflection from the well bottom and the well cap or TX/RX apparatus at the well head.

These first three confidence measures may be used individually or combined to rank order the clusters according to the likelihood each may be associated with a condition of the well (e.g., the true depth of liquid in the well). Said combination, called the chirp confidence herein, may be as simple as the multiplicative product of the three. Confidence_1, Confidence_2 and Confidence_3 may also be combined using data fusion methods with associated depths such as Dempster-Schafer or other methods known to those skilled in the art using the benefit of this disclosure. The composite confidence measure may be denoted Confidence_chirp herein and, may be associated with well depth according to various embodiments.

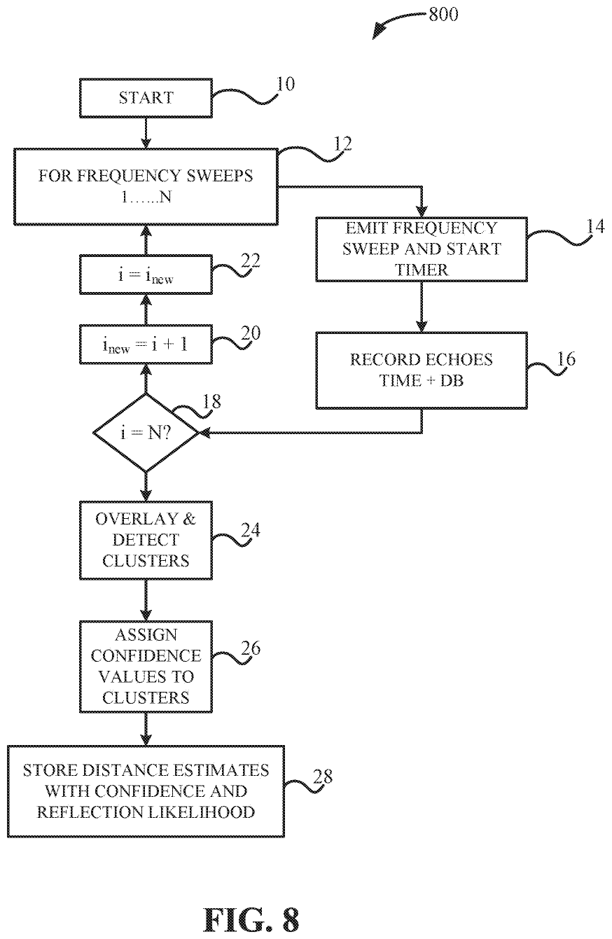

According to various embodiments, various composite confidence measures may be determined (e.g., a plurality of Confidence_chirps) and may be further analyzed using a second acoustic signal transmit and receive process using slowly-varying frequency of a continuous wave signal in the sonic range (e.g., frequency sweeps). The range of swept frequencies may be very wide within the intent of the instant disclosure. However, for various applications and, in some embodiments, to increase the speed of the results, narrower ranges may be identified. Beginning with the highest ranked chirp confidence and its associated well depth a frequency center point may be selected which has the quality of having a relatively small number of quarter wavelengths for said well depth. For example, for clusters with long TOF durations relatively low frequencies such as around 30-300 Hz may be selected. Also, as yet another example, for clusters with short TOF, such as for shallow wells, relatively higher frequencies may be selected for the center point as indicated in FIG. 8. Based on the estimated well depth for each said cluster the range of the sweep surrounding the center point frequency may be set such that at least two peaks and nulls of constructive and destructive standing wave interference may be detected within such a frequency sweep profile.

In various embodiments, a sweep profile may be performed sufficiently slowly to allow a standing wave to be established based on a TOF estimate of the cluster well depth plus a small margin. A sweep profile may be executed at a rapid slew rate and will introduce bias into the standing wave readings commensurate with the TOF of the well depth associated with the cluster from which the center point frequency was derived. The degree of tolerance of the final reading may be used to adjust the slew rate. Also, the slew might be produced by discrete steps such that each step may be of sufficient duration to establish a standing wave at its frequency and, thus, in various embodiments may help to eliminate or reduce bias. In some embodiments, when a finite number of discrete steps are used, the detection of peaks and nulls described below may be affected in a way which reduces accuracy. A skilled artisan may appreciate relative tradeoffs between a linear, analog sweep, and a stepped digital sweep using the benefit of this disclosure, each of which may be used individually or in various combinations according to various embodiments.

The frequency of this second series of acoustic outputs from TX may be thus swept at a given slew rate across a given sweep range, and the RX detects the standing wave amplitudes at the well head according to the quarter-wavelength relation (1+2N)λ/4 to find peaks and nulls.

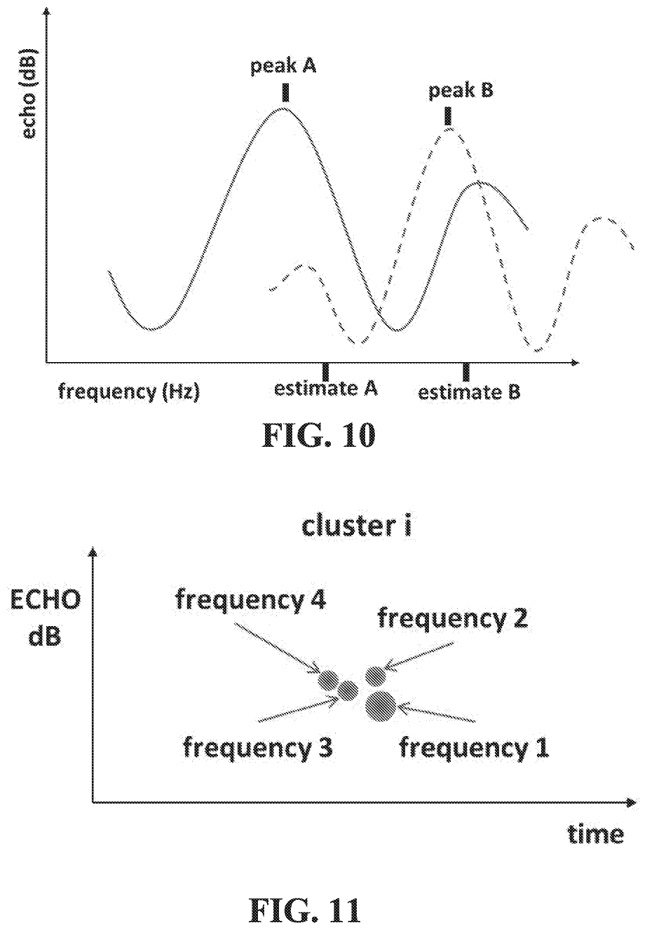

FIG. 10 illustrates possibly overlapping frequency sweep ranges estimated from the greatest chirp confidence cluster (“estimate A”) and the second greatest chirp confidence cluster (“estimate B”). More than two clusters may be used, however increasing the number of chirp clusters increases in general the overlap and destructive interference with other responses thereby eroding the signal-to-noise ratio (SNR). Thus, in some embodiments, the number of estimates may be limited to about 2 or 3 estimates. In some embodiments, (e.g., for deeper wells) a lesser number of estimates may be used, because the frequency difference between successive odd-quarter wavelength standing waves becomes an ever smaller fraction with smaller SNR and hence more difficult to detect reliably. The difference in frequency between adjacent peaks in the standing wave scan may be estimated from Equation (7):

$${f}_{k} - {f}_{k + 1} = \frac{c}{2 l} \qquad Eq . 7$$

The response of the series of frequency range sweeps surrounding estimate A and estimate B may be analyzed in comparison to a predicted response based on the well depths associated with the highest chirp confidence clusters. These will follow a sinusoidal shape with peaks and nulls separated according to the quarter-wavelength relation above, and summed over the two estimates.

In some embodiments the peak and null detection, and their associated difference in frequency (Δf=f₁−f₂) may be computed separately for each sweep to obtain a first estimate of the difference in frequency and hence a family of estimates for well depth. For each sweep associated with high confidence clusters the estimated depth of well i, may be computed according to Eq. 7. A fourth confidence measure Confidence_4 may be then computed according to Eq. 8:

$$Confidence\_ 4 ( i ) = {[ \frac{{l}_{chirp} - {l}_{sweep}}{{l}_{chirp} + {l}_{sweep}} ]}^{- 1} \qquad Eq . 8$$

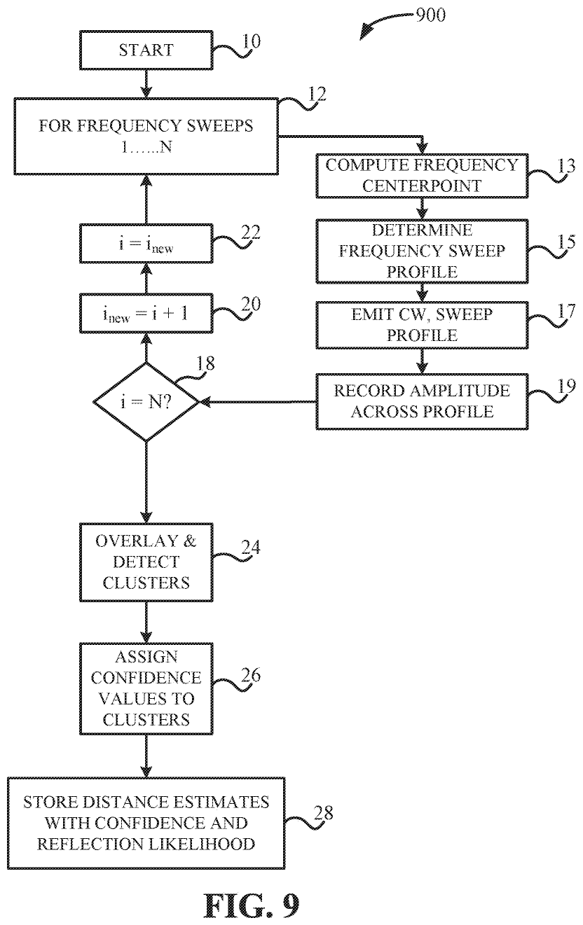

A final confidence for a characteristic of a well (e.g., the true well depth) may be computed as a composite confidence for each identified and top-ranked cluster by combining Confidence_chirp(i) and Confidence_4(i) to provide a final confidence value Confidence_final(i) for each cluster, either through simple multiplication or through use of data fusion methods. That cluster (i) for which Confidence_final(i) is greatest may be then selected by an algorithm, such as those exemplified in FIGS. 8 and 9.

FIG. 8 illustrates a flow chart of a logic sequence 800 according to an exemplary method. First, the logic sequence starts 10 then a frequency sweep for N sweeps is performed 12. The frequency is emitted and a timer is started 14 and the echoes including the lapsed time and the decibels are recorded 16. This is done for N times and may use the counter illustrated in step 18, step 20, and step 22. Then the collected data may be overlaid and clusters may be detected 24. Then confidence values may be assigned to the clusters 26 and then the distance estimates with confidence and reflection likelihood may be stored.

FIG. 9 illustrates a flow chart of another exemplary logic sequence 900 according to various embodiments. FIG. 9 may include may of the same steps as the logic sequence depicted in FIG. 8, but may also include computing a frequency centerpoint 13, determining a frequency sweep profile 15, emit a continuous wave/sweep profile 17, and record the amplitude across the profile 19.

In some embodiments, a robust algorithm, such as those exemplified in FIGS. 8 and 9 may allow for conditions under which Confidence_4 may be very small, and remove this from the computation of Confidence_final(i). Such conditions might be experienced where there are significant structural materials internal to the well that provide a multiplicity of reflecting surfaces, which may lead to a smearing out of the signals expected of the near-ideal case, as depicted in FIG. 7. In various embodiments if all Confidence_4(i) values lie below a certain threshold (e.g., 0.05), which may be experimentally determined according to the components in use, the value of Confidence_final(i) may be set equal to Confidence_chirp(i).

The final characteristic (e.g., estimate for the true well depth) may be then selected, and stored, reported, or displayed as desired by the user and facilitated by the apparatus. Upon selection of a characteristic of a well (e.g., the final estimate for true well depth), an additional analysis may be made within the cluster associated with Confidence_final(i) in order to estimate a second characteristic of the well (e.g., the gas mixture inside the well). For example, FIG. 11 shows a representative close-up view of a single cluster (i) and the four (4) chirp responses received.

TOF differences within a cluster may be expected to be relatively unrelated to temperature, pressure, and humidity level. This may be a simplifying assumption, and these effects may certainly be used to compensate for a more precise reading. Within atmospheric air, the presence of CO₂ may cause changes in the speed of sound especially in the ultrasonic range. Methane (CH₄) also may affect the speed of sound in the ultrasonic range. The ranges selected for the 4 frequencies shown in FIG. 11 may be such that frequency numbers 1 and 2 may be within a range where sound velocity may be constant over frequency. The difference between them may thus be used as an estimate of error in this measurement. Note also that repeated readings at the same frequency may also be used to provide improved estimates of the error in TOF.

Frequencies 3 and 4 of FIG. 11, being within the wide range known as ultrasonic, may be pre-selected such as to give a difference which may be substantially different in the response of CO₂ and CH₄. Thus, the difference in TOF of these latter frequencies, relative to the sonic range frequencies may be used in a mixture equation to estimate the relative percentages of carbon dioxide and natural gas/methane inside the well. Note that more than two ultrasonic frequencies may be used to estimate mixture percentages. With a 2-part mixture the ratio of concentrations of the two constituent gases may be approximated by a linear interpolation between the two frequencies. In general the number of suspected components of the mixture needs to match or be less than the number of points used in the multi-dimensional mixture formulae. Thus, without a priori knowledge of the possible gas species inside the well, the mixture formula results of composition ratios may be an estimation or approximation. However, with the benefits of this disclosure, one skilled in the art should in general be able to easily identify a change in gas composition over time and thus indicate the need for a more detailed and exacting gas composition measurement, such as gas chromatography or other such methods as known to those skilled in the art.

This mixture may be an indirect reading of the presence and amount of natural gas which may be present within the well. Also, because some gasses (e.g., methane) may be more buoyant than air, they may occupy the upper portions of the well, so the reading obtained will be an averaging of the entire column of gases. The mixture formula, which may be simple for those skilled in the art with the benefit of this disclosure, then provides an output of the gas composition in the well, which may be stored, displayed, or communicated to a remote device.

To compute dynamic response of the well the entire sequence above, or a subset thereof, may be repeated. The outputs of true well depth and gas composition may then be plotted over time for beneficial purposes of monitoring the well for recovery of liquids or intrusion of gases.

Multiple wells within a well field may be monitored dynamically in this way to determine various important parameters such as were described in the Background section above. Wells may be monitored on-demand, periodically, or continuously. Readings may be taken remotely, on-line via connection to other devices, or on-demand in response to a command signal from a querying device or person. Readings may be continuously displayed, or stored in databases for further and future analysis, or summarized in statistics. Dynamic readings may be processed according to routines known to those skilled in the art to provide high level metrics on well state of health.

While this disclosure has been described as having an exemplary design, the present disclosure may be further modified within the spirit and scope of this disclosure. This application may be therefore intended to cover any variations, uses, or adaptations of the disclosure using its general principles. Further, this application may be intended to cover such departures from the present disclosure as come within known or customary practice in the art to which this disclosure pertains.

Furthermore, the connecting lines shown in the various figures contained herein may be intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced may be not to be construed as critical, required, or essential features or elements. Moreover, reference to an element in the singular may be not intended to mean “one and only one” unless explicitly so stated, but rather “one or more.” Moreover, where a phrase similar to “at least one of A, B, or C” may be used, it may be intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases may be not necessarily referring to the same embodiment. Further, when a particular feature, structure, or characteristic may be described in connection with an embodiment, it may be submitted that it may be within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, as used herein, the terms “comprises,” “comprising,” or any other variation thereof, may be intended to cover a non-exclusive inclusion, such that a process, method, article, or apparatus that comprises a list of elements does not include only those elements but may include other elements not expressly listed or inherent to such process, method, article, or apparatus.

1. (canceled)

2. A method for operating a processing system to determine a first property of a well, optionally a depth of the well, comprising:
receiving, by the processing system, acoustic reflection information, wherein the acoustic reflection information is representative of echos received from the well in response to a plurality of acoustic pulses applied to the well, and wherein the plurality of acoustic pulses include multiple frequencies;
identifying, by the processing system from the acoustic reflection information, for each of the multiple frequencies, a frequency set of one or more return readings, wherein each return reading includes information representative of a time of flight (TOF) and attenuation with respect to an associated acoustic pulse applied to the well;
identifying, by the processing system from the frequency sets of return readings, TOF clusters of the return readings, wherein the return readings of the TOF clusters may be characteristic of the first property of the well; and
determining, by the processing system, a confidence measure for each TOF cluster of each frequency set, wherein the confidence measure is a measure of whether the return readings of the TOF cluster are characteristic of the first property of the well.

3. The method of claim 2 and further including ranking the TOF clusters based on the determined confidence measures.

4. The method of claim 2, further comprising:
determining a plurality of confidence measures for each for each TOF cluster, wherein each of the confidence measures is determined by a different methodology; and
determining a composite confidence measure for each TOF based on the plurality of confidence measures.

5. The method of claim 4 wherein determining the plurality of confidence measures for each TOF cluster includes determining confidence measures by one or more methods from the group including: (1) determining a proximity of the return readings of the TOF cluster to a centroid of the TOF cluster; (2) determining a proximity of the TOF cluster to an expected attenuation schedule, or (3) determining whether the cluster is an echo of another of the clusters.

6. The method of claim 5 wherein receiving the acoustic reflection information includes receiving acoustic reflection information representative of echos in response to a plurality of chirp pulses having multiple frequencies.

7. The method of claim 6 wherein:
receiving the acoustic reflection information includes receiving acoustic reflection information representative of echos in response to a plurality of continuous wave scanned frequency pulses; and
the method further comprises:
identifying, by the processing system, continuous wave return readings, including resonance values of the continuous wave return readings, wherein the continuous wave return readings may be characteristic of the first property of the well; and
determining, by the processing system, a confidence measure for the continuous wave return readings based on the resonance values, wherein the confidence measure for the continuous wave return readings is a measure of whether the continuous wave return readings are characteristic of the first property of the well.

8. The method of claim 7 and further comprising evaluating the composite confidence measure based on the confidence measure for the continuous wave return reading.

9. The method of claim 2 wherein:
receiving the acoustic reflection information includes receiving acoustic reflection information representative of echos in response to a plurality of chirp pulses having multiple frequencies; and
determining the confidence measure for each TOF cluster includes determining the confidence measure based on the chirp pulses.

10. The method of claim 9 wherein:
receiving the acoustic reflection information includes receiving acoustic reflection information representative of echos in response to a plurality of continuous wave scanned frequency pulses; and
the method further comprises identifying, by the processing system, continuous wave return readings, including resonance values of the continuous wave return readings, wherein the continuous wave return readings may be characteristic of the first property of the well.

11. The method of claim 9 wherein the method further includes:
determining a confidence measure for the continuous wave return readings based on the resonance values, wherein the confidence measure for the continuous wave return readings is a measure of whether the continuous wave return readings are characteristic of the first property of the well; and
determining a composite confidence value based on the confidence measures of the TOF clusters and the confidence measure for the continuous wave return readings.

12. The method of claim 9 wherein determining the confidence measure includes determining a confidence measure by one or more methods from the group including: (1) determining a proximity of the return readings of the TOF cluster to a centroid of the TOF cluster; (2) determining a proximity of the TOF cluster to an expected attenuation schedule, or (3) determining whether the cluster is an echo of another of the clusters.

13. The method of claim 2 wherein determining a confidence measure includes determining a confidence measure by one or more methods from the group including: (1) determining a proximity of the return readings of the TOF cluster to a centroid of the TOF cluster; (2) determining a proximity of the TOF cluster to an expected attenuation schedule, or (3) determining whether the cluster is an echo of another of the clusters.

14. The method of claim 2 for operating the processing system to determine a second property of the well, optionally a gas composition in the well, comprising identifying TOF differences between return readings having different frequencies in a TOF cluster.

15. The method of claim 2, further comprising:
repeating the method over time; and
determining, by the computer, a dynamic response of the well.
